(19) United States
(12) Patent Application Publication
(10) Pub. No.: US 2007/0145629 A1
(43) Pub. Date: Jun. 28, 2007

(54) Method and device for producing miniature objects or microstructured objects

(76) Inventors: Robby Ebert, Chemnitz (DE); Horst Exner, Mittweida (DE); Lars Hartwig, Mittweida (DE); Bernd Keiper, Burgstadt (DE); Sascha Klotzer, Gera (DE); Peter Regenfuss, Mittweida (DE)

Correspondence Address: WILLIAM COLLARD;COLLARD & ROE, P.C., 1077 NORTHERN BOULEVARD, ROSLYN, NY, 11576, US

(21) Appl. No.: 10/546,954

(22) PCT Filed: Feb. 26, 2004
(86) PCT No.: PCT/EP04/01892

§ 371 Date: Jun. 2, 2006

(30) Foreign Application Priority Data
Feb. 26, 2003 (DE) 103-09-519.5

(51) Int. Cl. B29C 35/08

(52) U.S. Cl. 264/157; 264/497; 264/442; 425/174.4

(57) ABSTRACT

The invention relates to a pole terminal for producing an electrical connection. Said pole terminal comprises a metallic conductive body which is surrounded by an insulating body which can be fixed to the housing of an electrical appliance, and on which a tensioning nut can be screwed, said tensioning nut clamping the electrical conductor to be connected against the conductive body, establishing an electrical contact. The aim of the invention is to improve one such pole terminal in such a way that the conductive body can be produced from a material which is highly conductive, such as silver or copper. To this end, the conductive body is produced from a material exhibiting higher conductivity, by means of noncutting deformation, and is connected to the surrounding insulating body to form a composite body. Preferably, the conductive body is embodied as a stamped part which is machined by bending strain.

The invention pertains to a method for producing miniature objects or microstructured objects on a support in a processing chamber for a vacuum or a protective gas atmosphere by means of the laser beams of at least one laser, as well as to devices for producing miniature objects or microstructured objects that comprise at least one respective support for the miniature objects or microstructured objects, a reservoir for particles, a device for transporting the particles from the reservoir to the support arranged in a processing chamber for either a protective gas atmosphere or a vacuum, and at least one laser that is arranged inside or outside the processing chamber and the laser beams of which sweep the surface of the support with the particles.

According to DE 195 38 257 C2 (method for producing a three-dimensional object), the object to be produced is provided with a three-dimensional support construction consisting of an inner core region and an outer envelope region. In this case, the core region is preferably exposed twice in order to achieve a more significant solidification. However, the envelope region is only exposed once. The entire surface of the envelope region is situated between the object and the support construction. The envelope region is soft such that the objects can be separated from the support construction with the least possible expenditure of force and tools. However, problems arise in the separation of very small or microstructured objects from the support construction because these objects can be very easily destroyed during the separation. In addition, working surfaces for the tools need to be provided. If several objects are situated on one support, it is very difficult to realize such a separation without damages. In other words, support constructions of this type are not suitable for producing several miniature objects or microstructured objects on one support.

The invention disclosed in Claims 1 and 11 is based on the objective of producing miniature objects or microstructured objects on a support in such a way that the finished objects can be easily separated from the support and/or from one another.

This objective is attained with the characteristics disclosed in Claims 1 and 11.

The advantages attained with the invention can be seen, in particular, in that it is possible to easily produce miniature objects as well as microstructured objects. The miniature objects and the microstructures objects are produced of particles that are applied layer-by-layer. Spacers that also consist of particles applied layer-by-layer are situated between the support and the miniature objects or microstructured objects. The particular advantage in this respect can be seen in that these spacers are produced by means of irradiation with laser beams in such a way that particles are sintered in a partially laminar, laminar or linear fashion in the respective plane and destructible spacers are produced that have small contact area structures and contain voids and consequently can be easily separated from the support and from the miniature objects or microstructured objects. Such voids may also be continuous. This results in spacers with a certain static strength such that the miniature objects or microstructured objects can be securely positioned relative to one another on the support and/or in the powder bed. These spacers have a low resistance to shearing forces such that the miniature objects or microstructured objects can be easily separated by applying such forces. Another advantage is that the miniature objects or microstructured objects and the spacers may consist of the same material, i.e., the miniature objects or microstructured objects as well as the spacers are produced by irradiating a layer with laser beams. This means that projecting miniature objects or microstructured objects with projections can be easily produced and subsequently separated. The separable spacers as well as the miniature objects or microstructured objects are produced layer-by-layer, namely by applying and selectively sintering the particles with the laser beams of a laser. The processing parameters for the separable spacers are chosen such that the particles are sintered in a partially laminar, laminar or linear fashion in the respective plane and destructible spacers are produced that have small contact area structures and contain voids and consequently can be separated from the support and from the miniature objects or microstructured objects. A static solidification of a defined material volume is achieved with these measures. In this case, homogenous separable spacers are obtained that have constant parameters over the entire cross section, wherein the spacer can be completely separated despite its entire boundary surface being in contact with the miniature objects or microstructured objects. The miniature objects or microstructured objects are produced on and in these separable spacers of the same material, namely by means of selective irradiation with the laser beams of the laser or a laser. In this case, the parameters are chosen such that a shear-resistant sintering of the particles is achieved. The support is subjected to ultrasound after the miniature objects or microstructured objects are produced thereon such that they are separated from the support as well as from the separable spacers without requiring any auxiliary means. The support is coupled to an ultrasonic generator for this purpose. Since damages to the miniature objects or microstructured objects and the support are prevented during the separation, the support can be utilized several times for the production of miniature objects or microstructured objects without requiring any intermediate treatment. One advantageous transport device for a layer-by-layer application of particles onto the support consists of at least one closed annular doctor blade that can be moved in at least one plane that lies parallel to the support by means of a construction element and is either rotatably supported and coupled to a drive or can be moved in the x-direction and the y-direction by means of coupled drives. This arrangement makes it possible to at least rotate or move the doctor blade over either the reservoir or a surface situated adjacent to the support and the support itself, wherein the layer-by-layer application of particles onto the support is either realized with particles from a separate reservoir or from the annular doctor blade that acts as a reservoir. The irradiation with the laser beams of at least one laser produces a sintered connection between the particles within a layer and from one layer to the adjacent layer. In this case, separable spacers and miniature objects or microstructured objects are produced successively and/or adjacently. Another advantage can be seen in that it is possible to utilize at least two reservoirs that contain particles of different materials. This means that miniature objects or microstructured objects with vertical property gradients can be produced in the form of layers consisting of different materials. A homogenous layer application is achieved because the annular doctor blade ensures a uniform application of the layers in all directions.

Advantageous embodiments of the invention are disclosed in Claims 2-10 and 12-16.

According to the additional development proposed in Claim 2, separable spacers are also realized between the miniature objects or microstructured objects. Consequently, it is also possible to produce tall miniature objects or microstructured objects on one support. The separable spacers prevent these miniature objects or microstructured objects from tipping over.

The additional development proposed in Claim 3 also pertains to separable spacers between the miniature objects or microstructured objects. These spacers consist of at least one prefabricated element, to which at least one miniature object or microstructured object is rigidly connected such that the prefabricated element forms an integral part of the miniature object or microstructured object. This advantageously makes it possible to apply and rigidly connect microstructures on/to prefabricated elements in order to produce a microstructured object.

A continuous production method can be realized with the additional development disclosed in Claim 4, according to which the pulse frequency and the sweeping speed of the laser are identical for the production of the miniature objects or microstructured objects and the spacers and the laser power is lower during the production of the spacers than during the production of the miniature objects or microstructured objects. The multiple irradiation of individual regions of the respective layer is prevented in this fashion. It is economically advantageous that the production time can be reduced without having to increase the laser power, namely by simply increasing the pulse frequency and the sweeping speed.

According to the additional development disclosed in Claim 5, the layers of particles are advantageously applied by means of a printing technique, spraying or at least one doctor blade.

According to the additional development disclosed in Claim 6, a layer consisting of a paste containing the particles is acted upon in a vacuum with a pressure that lies slightly above the vapor pressure of the binder and heated by means of laser beams such that the binder is advantageously separated from the particles.

A dense miniature object or microstructured object can be produced with the additional development disclosed in Claim 7, according to which the respectively applied layer is compacted before the irradiation with laser beams by acting upon the support and/or the doctor blade with ultrasound and/or horizontally turning the doctor blade. Another advantage of subjecting the support to ultrasound can be seen in that the ultrasonic generator coupled to the support can be utilized for compacting the particles as well as for respectively separating the miniature objects or microstructured objects from the separable spacers and from the support.

According to the additional development disclosed in Claim 8, layers consisting, in particular, of pastes can be uniformly applied without being destroyed by an oppositely directed movement of the doctor blade.

The additional development disclosed in Claim 9 makes it possible to realize material mixtures that are homogenous on a micrometer scale and/or have vertical material or property gradients and material or property boundaries in the miniature objects or microstructured objects or to produce entirely new materials. This means that it is possible to realize metallic mixtures that could otherwise only be produced under microgravitational conditions. The utilization of materials with different colors simultaneously makes it possible to realize various designs in accordance with the respective application or use.

A layer-by-layer dithering method according to the additional development disclosed in Claim 10 makes it possible to realize vertical color gradients in the outer layer of the miniature objects or microstructured objects.

Various advantageous utilizations of the invention can be realized with the additional developments disclosed in Claims 12 and 13. These embodiments make it possible, in particular, to realize a uniform application and a pre-compacting of the particles. An additional axial displacement of the annular doctor blade away from the support allows the application of pasty materials containing the particles in the form of a thin layer, namely because this layer is not contacted by the doctor blade during its return movement. An additional rotational movement of the doctor blade about its axis of symmetry can be achieved with an additional drive and leads to a uniform application and compaction of the layer. The movements of a coaxial ram within the annular doctor blade also result in a compaction of the powder.

According to the additional development disclosed in Claim 14, the doctor blade is coupled to an ultrasonic generator such that another option is provided for pre-compacting the particles in order to produce dense miniature objects or microstructured objects and for realizing an improved sliding movement and separation of the particles along/from the inner wall of the doctor blade.

Advantageous effects of the laser beam are achieved with the additional development disclosed in Claim 15, according to which a mask for realizing a square cross section of the laser beam or a homogenizer or a beam shaping unit that generates an intensity distribution in the form of an inverse Gauss profile is arranged downstream of the laser referred to the beam direction. A square laser beam cross section makes it possible to irradiate the surface of the layer in an optimally selective fashion during the sweep of the laser beam, namely without any overlaps and the resulting locally elevated temperatures that inevitably occur when using a laser beam with a round cross section. A homogenization of the laser radiation results in a homogenous and selective irradiation of the layer without locally raised intensities. Laser radiation in which the intensity has an inverse Gauss profile makes it possible to utilize laser pulses of high intensity without cracking off particles.

The annular doctor blade can be moved into a variety of positions in the doctor blade plane with the additional development disclosed in Claim 16, according to which the annular doctor blade is coupled to either a plane rotary gear or a displaceable device of variable length. This provides the advantage that the doctor blade is able to access different reservoirs in practically any sequence and can be guided over differently structured regions of the doctor blade plane in order to mix several components or to clean the doctor blade.

Embodiments of the invention are illustrated in the figures and described in greater detail below. The schematic figures respectively show:

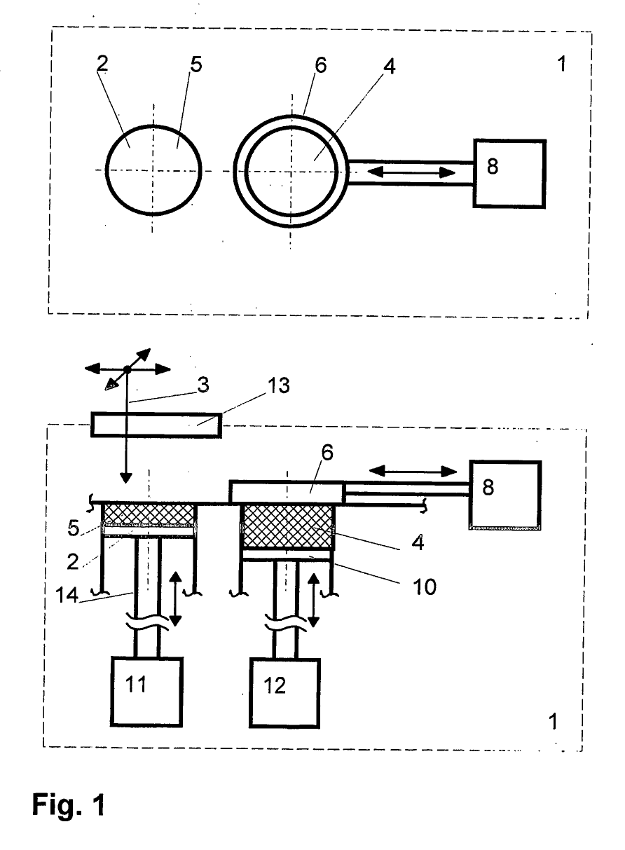

FIG. 1, a top view and a side view of a device for producing miniature objects or microstructured objects on a support arranged in a processing chamber by means of laser beams, namely with one doctor blade and one reservoir;

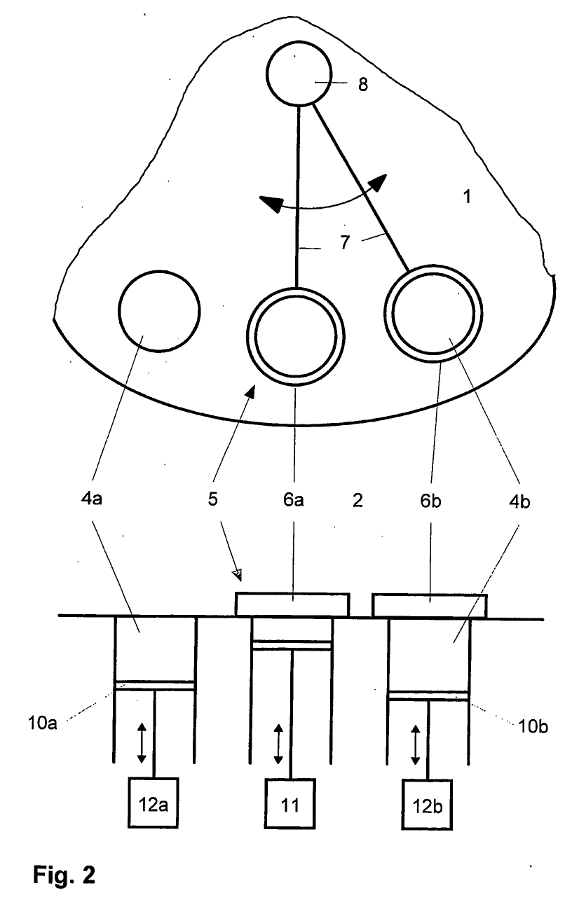

FIG. 2, a top view and a side view of a device with two doctor blades and two reservoirs;

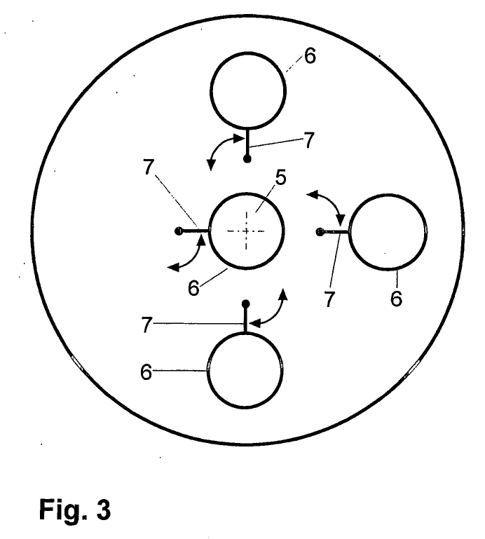

FIG. 3, a device with the production space situated in the center and with several pivoted annular doctor blades, and

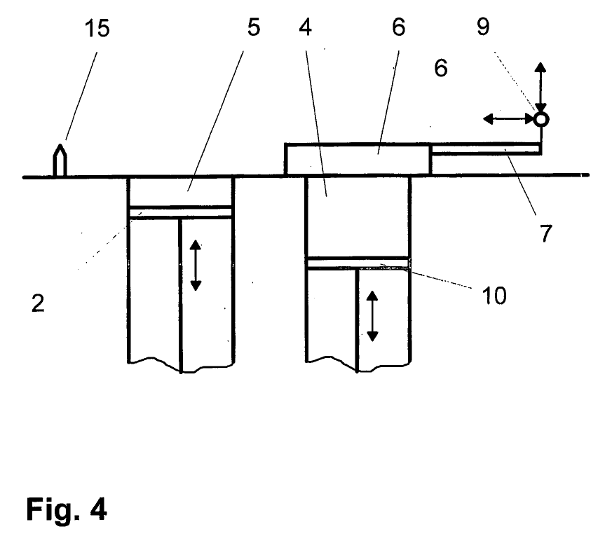

FIG. 4, a device with an annular doctor blade, a reservoir for a paste or a gel containing the particles and a stripper for cleaning the annular doctor blade.

The following detailed description pertains to methods and devices for producing miniature objects or microstructured objects on a support 2 in a processing chamber 1 for a vacuum or a protective gas atmosphere by means of the laser beams 3 of at least one laser.

### 1. APPLICATION EXAMPLE

The method is used for producing miniature objects of tungsten with a resolution <50 μm. In this case, a support 2 is arranged in a production space 5 for the miniature objects within the processing chamber 1, wherein a reservoir 4 is provided for particles in the form of tungsten nanopowder, as well as a device for transporting the particles from the reservoir 4 to the production space 5 and the support 2. The particles of the tungsten nanopowder preferably have a size of 300 nm. The transport device consists of a closed annular doctor blade 6. A circularly designed annular doctor blade 6 is arranged on at least one construction element that is coupled to at least one drive 8. The construction element may simply consist of a rod-shaped element 7 that is connected to the annular doctor blade 6 and fixed on a translatory or rotatory drive 8. In the latter instance, the annular doctor blade 6 carries out a circular movement, wherein at least one production space 5 with a support 2 and at least one reservoir 4 are arranged in the path of the annular doctor blade. FIG. 1 schematically shows such an arrangement with a support 2, an annular doctor blade 6 and a reservoir 4 in the form of a top view and a side view, wherein FIG. 2 schematically shows a device with a support 2, two annular doctor blades 6a, 6b and two reservoirs 4a, 4b in the form of a top view and a side view. In one embodiment, the production space 5 is arranged in the center of the processing chamber 1 and several pivoted annular doctor blades 6 are arranged around this production space 5. The production space 5 is situated within the pivoting range of the annular doctor blade 6. A schematic top view of such an arrangement is shown in FIG. 3. In other embodiments, the annular doctor blade 6 may
be fixed on an adjustable device of variable length, for example, two telescoping elements, and coupled to a rotatory drive,
be fixed on an adjustable device of variable length that is coupled to a translatory drive in such a way that the annular doctor blade can be moved in a x-plane and a y-plane, or
be fixed on a plane rotary gear.

The annular doctor blade 6 transforms powder with a low bulk density into layers with a higher density, namely by initially producing a thicker layer that is sheared off due to the successive contradirectional application with the annular doctor blade 6, in the interior of which the entire or apportioned powder supply is situated. During this process, the applied layer is simultaneously compressed and excess powder remains in the interior of the doctor blade or is returned into the reservoir 4. The support 2 can be moved relative to the annular doctor blade 6 within the processing chamber 1 by means of a drive 11, and the bottom 10 of the reservoir 4 can be moved relative to the annular doctor blade by means of another drive 12. It is advantageous that the drive of the annular doctor blade 6 may be connected to another drive in the form of a drive system 9 such that the annular doctor blade 6 can also be moved relative to the support 2 and the bottom 10 of the reservoir 4. The laser is arranged outside the processing chamber 1 such that the laser beams 3 are incident on the support 2 situated in the processing chamber 1 via a scanner and a window 13. Although not illustrated in the figures, it is common practice to deflect laser beams 3 or to couple the laser to a displacement device. It is preferred to utilize laser beams 3 of a Q-switched Nd:YAG laser with a wavelength of 1064 nm and a pulse duration of 100 ns in the monomode. In the embodiment shown, a mask for producing a laser beam 3 of square cross section and/or a homogenizer or a beam shaping unit that generates an intensity distribution in the form of an inversed Gauss profile may be arranged downstream of the laser referred to the beam direction. In a first step, the processing chamber 1 is evacuated to a pressure <10⁻⁵ mbar and the tungsten nanopowder is dried. Subsequently, the process gas, preferably argon or helium, is introduced until a pressure of 500 mbar is reached. Subsequently, the layers consisting of tungsten nanopowder are applied in the dry state, wherein each layer is respectively irradiated with laser beams 3 after its application in such a way that the tungsten nanoparticles are sintered in a partially laminar, laminar or linear fashion in the respective plane and several separable spacers are produced that have small contact area structures and contain voids. During this process, a certain static strength as well as a low resistance to shearing forces is realized. In other words, separable spacers are produced between the support 2 and the miniature objects. After the spacers are produced, additional layers consisting of tungsten nanopowder are applied in the dry state. After each application, the respective layer is irradiated with the laser beams 3 in such a way that the tungsten nanoparticles are continuously connected to one another in this plane and to the layer produced directly thereunder in the form of a wall and an inner region corresponding to the contour of the miniature object in this plane. The separable spacers and the miniature objects are produced on the support 2 in this fashion. During the production of the miniature objects, certain layers may also be irradiated in such a way that the tungsten nanoparticles are sintered in a partially laminar, laminar or linear fashion in the respective plane and separable spacers are produced that have small contact area structures and contain voids. This means that separable spacers are also situated between the miniature objects. When producing the separable spacers, it is preferred to utilize a pulse frequency of 8 kHz at a laser power of 0.3 W and a sweeping speed of 600 mm/s. The walls and the inner regions are created by means of a solid sintering process, in which a pulse frequency of 8 kHz is used at a laser power of 1 W and a sweeping speed of 600 mm/s. The application of the layers consisting of tungsten nanopowder containing tungsten nanoparticles is realized by lowering the support 2 by ≦1 μm and subsequently applying the particles. The respectively applied layer can be compacted before being irradiated with the laser beams 3 by acting upon the support 2 with audible sound. The oscillations with frequencies of approximately 500 Hz are preferably generated by the lifting axle 14 of the support 3. The miniature objects are separated from the support and from the spacers by acting upon the support 2 carrying the miniature objects with ultrasound, wherein the support 2 is coupled to an ultrasonic generator for this purpose.

In another embodiment, miniature objects of copper and tungsten/copper are produced by utilizing either a powder consisting of copper microparticles or a mixture of copper microparticles and tungsten nanoparticles. The support 2 is lowered in increments of approximately 2 μm.

Miniature objects of silver and tungsten/silver can be produced in accordance with another embodiment by utilizing either a powder of silver microparticles or a mixture of silver microparticles and tungsten nanoparticles. The support 2 is lowered in increments of approximately 2 μm in this case.

Miniature objects of titanium can be produced in accordance with another embodiment by utilizing a powder of titanium microparticles and/or nanoparticles. In this case, the support 2 is lowered in increments of approximately 2 μm.

Miniature objects of aluminum can be produced in accordance with another embodiment by utilizing a powder of aluminum microparticles. The sintering process is carried out with a low laser power of 0.8 W in this case, wherein a laser power of 0.25 W is used for producing the separable spacers.

According to another embodiment, miniature objects of aluminum/titanium can be produced by utilizing a mixture of aluminum and titanium microparticles and/or nanoparticles. In this case, the sintering process is carried out with a laser power of 0.8 W, wherein a laser power of 0.25 W is used for producing the separable spacers.

In another embodiment, the layer consists of a paste containing tungsten nanoparticles and is pre-dried in a vacuum under a pressure that lies slightly above the vapor pressure of the binder. The binder is removed in a heating process realized with the laser beams 3. Before its return movement, the annular doctor blade 6 is raised and then guided over a cleaning device in the form of a rubber lip 15 for cleaning purposes (as shown in FIG. 3).

### 2. APPLICATION EXAMPLE

The following detailed description pertains to a method and a device for producing microstructured objects in the form of tooth inlays on a support 2 in a processing chamber 1 for a vacuum or a protective gas atmosphere by means of the laser beams 3 of at least one laser.

The device essentially corresponds to that used in the first embodiment. However, the method is carried out under a protective gas atmosphere. The layers are applied in the form of a paste or a gel. The layers are pre-dried and the binder is evaporated by rapidly sweeping the laser beam 3 over the entire layer. The layers have a thickness between ≧5 μm and ≦20 μm. The laser operates in the multimode such that a larger beam spot diameter is realized. The laser power preferably lies at 3 W for sintering the microstructured objects and 1 W for sintering the separable spacers. The doctor blade is preferably realized in the form of a closed annular doctor blade 6. After the application process, the annular doctor blade 6 is raised with the aid of the drive system 9 and guided over a rubber lip 15 for cleaning purposes. After the cleaning process, the doctor blade 6 is once again positioned above the reservoir 4a and filled anew. The device also contains at least one other reservoir 4b for a paste or gel. The at least two reservoirs 4a, 4b contain pastes or gels that have different colors after the sintering process, preferably white and grayish-yellow. During the production process, all colors between white and grayish-yellow can be realized by applying alternating layers of the different pastes or gels with the aid of a dithering method. This makes it possible to optimally adapt the color of the inlay to the tooth. In an alternative embodiment, two annular doctor blades 6 are used that simultaneously serve as reservoirs and can be moved in a circular fashion. The annular doctor blade 6 is loaded from the top through the hinged coupling window 13 for the laser beams 3. The advantage of this variation can be seen in that the annular doctor blade 6 only needs to be moved in one direction such that it can be prevented from passing over the newly applied layer once again. In this case, it is not necessary to raise the annular doctor blades. The doctor blades 6 are moved past a stripper in order to be cleaned.

In other embodiments, a miniature object or a microstructured object can be realized with an integral prefabricated element. The prefabricated element is arranged on the support 2 in this case. During the initial application, the space around the prefabricated element and above the support 2 is completely filled with powder. This sufficiently fixes the prefabricated element on the support 2. Layers with or of particles are subsequently applied and the respective layers are irradiated with laser beams 3 after their application in accordance with the contours of the miniature object or microstructured object in this plane. This causes the particles to be continuously connected to one another in this plane by sintering, namely in the form of a wall and an inner region of the miniature object or microstructured object. In addition, the particles in the first layer are also connected to the prefabricated element such that a miniature object or microstructured object is produced, wherein said particles are simultaneously sintered into separable spacers that have small contact area structures and contain voids in a partially laminar, laminar or linear fashion in the respective plane. During this process, a certain static strength and a low resistance to shearing forces are realized. Ultrasound is preferably utilized for separating the miniature objects or microstructured objects and the spacers. The support 2 and the miniature objects or microstructured objects are not solidly fused together such that they can be easily separated.

1. A method for producing miniature objects or microstructured objects on a support in a processing chamber for a vacuum or a protective gas atmosphere by means of the laser beams of at least one laser,
wherein layers with or of particles are applied and the respective layers are irradiated with laser beams (3) after their application in such a way that particles are sintered in a partially laminar, laminar or linear fashion in the respective plane and separable spacers are produced that have small contact area structures and contain voids, whereby a certain static strength as well as a low resistance to shearing forces is realized, in that layers with or of particles are applied and the respective layers are irradiated after their application in accordance with the contours of the miniature object or microstructured object in this plane such that particles are continuously connected to one another in this plane by sintering in the form of a wall and an inner region of the miniature object or microstructured object and miniature objects or microstructured objects are produced, and in that the support (2) with the miniature objects or microstructured objects and the separable spacers is subjected to ultrasound in order separate the miniature objects or microstructured objects from the support (2) and from the separable spacers.

2. The method according to claim 1,
wherein layers with or of particles are applied and the respective layers are irradiated with laser beams (3) after their application in such a way that particles are sintered in a partially laminar, laminar or linear fashion in the respective plane and separable spacers are produced that have small contact area structures and contain voids, whereby a certain static strength as well as a low resistance to shearing forces is realized, in that layers with or of particles are applied and the respective layers are irradiated with laser beams (3) after their application in accordance with the contours of the miniature object or microstructured object in this plane, namely in such a way that particles are continuously connected to one another in this plane by sintering in the form of a wall and an inner region of the miniature object or microstructured object and miniature objects or microstructured objects are produced, wherein particles are also sintered in a partially laminar, laminar or linear fashion in the respective plane such that separable spacers are produced that have small contact area structures and contain voids, whereby a certain static strength as well as a low resistance to shearing forces is realized, and in that the support (2) with the miniature objects or microstructured objects and the separable spacers is subjected to ultrasound in order to separate the miniature objects or microstructured objects from the support (2) and from the separable spacers.

3. The method according to claim 1,
wherein layers with or of particles are applied on at least one prefabricated element that is arranged on the support (2) and surrounded by layers with or of particles, in that the respective layers are irradiated after their application by means of laser beams (3) in accordance with the contour or the contours of the miniature objects or microstructured objects in this plane, namely such that particles are continuously connected to one another in this plane by sintering in the form of a wall and an inner region of the miniature object or microstructured object and, in the first layer, the particles are also connected to the prefabricated element such that a miniature object or microstructured object is produced, in that the particles are simultaneously sintered into separable spacers that have small contact area structures and contain voids in a partially laminar, laminar or linear fashion in this plane, whereby a certain static strength and a low resistance to shearing forces is realized, and in that the support (2) with the miniature objects or microstructured objects and the separable spacers is subjected to ultrasound in order to separate the miniature objects or microstructured objects from the separable spacers.

4. The method according to claim 1,
wherein the pulse frequency and the sweeping speed of the laser beams (3) over the layers are identical for the production of the miniature objects or microstructured objects and the spacers, wherein the laser power is lower during the production of the spacers than during the production of the miniature objects or microstructured objects, or in that the laser power is identical during the production of the miniature objects or microstructured objects and the spacers, wherein the pulse frequency and the sweeping speed of the laser beams (3) over the layers are higher during the production of the spacers than during the production of the miniature objects or microstructured objects.

5. The method according to claim 1,
wherein the layers with or of particles are applied by means of a printing technique, spraying or at least one doctor blade.

6. The method according to claim 1,
wherein layers of a paste containing the particles are acted upon in a vacuum with a pressure that lies slightly above the vapor pressure of the binder and heated by means of laser beams (3) in order to remove the binder from the layers.

7. The method according to claim 5,
wherein the respectively applied layer is compacted before the irradiation with laser beams (3) by acting upon the support and/or the doctor blade with audible sound or ultrasound and/or by horizontally turning the doctor blade.

8. The method according to claim 5,
wherein the doctor blade is guided over the support (2) in one direction along a closed moving path.

9. The method according to claim 1,
wherein at least two different materials with identical or different colors are used for different layers.

10. The method according to claim 9,
wherein a layer-by-layer dithering method is used.

11. A device for producing miniature objects or microstructured objects with the method according to claim 1, with at least one respective support (2) for the miniature objects or microstructured objects, a reservoir (4) for particles, a device for transporting particles from the reservoir (4) to the support (2) arranged in a processing chamber (1) for either a protective gas atmosphere or a vacuum, and with at least one laser that is arranged inside or outside the processing chamber (1) and the laser beams (3) of which can sweep the surface of the support (2) with the particles,
wherein the transport device consists of least one closed annular doctor blade (6) that can be moved in at least one plane that lies parallel to the support (2) by means of a construction element and is either rotatably supported and coupled to a drive or can be moved in the x-direction and the y-direction by means of coupled drives, namely such that the doctor blade (6) is able to at least rotate or move over either the reservoir or a surface situated adjacent to the support (2) and the support (2) itself, wherein the application onto the support (2) in a layer-by-layer fashion is either realized with particles from a separate reservoir (4) by the annular doctor blade (6) or with particles from the annular doctor blade (6) that acts as a reservoir, wherein the irradiation with the laser beams (3) of at least one laser produces a sintered connection between the particles within a layer and from one layer to the adjacent layer, and wherein separable spacers and miniature objects or microstructured objects are produced successively and/or adjacently.

12. The device according to claim 11,
wherein the support (2) can be moved relative to the annular doctor blade (6) by means of a drive (11) and/or the bottom (10) of the reservoir (4) can be moved relative to the annular doctor blade (6) by means of a drive (12) and/or the annular doctor blade (6) can be moved relative to the support (2) as well as either the reservoir (4) or the surface situated adjacent to the support (2) by means of a drive (8).

13. The device according to claim 11,
wherein the annular doctor blade (6) is provided with a fixed ram or a ram that can be displaced by means of a drive mechanism and at least regionally closes the doctor blade (6).

14. The device according to claim 11,
wherein the annular doctor blade (6) and/or the support (2) are respectively coupled to an audible sound generator and/or ultrasonic generator.

15. The device according to claim 11,
wherein a mask for realizing a square cross section of the laser beam (3) or a homogenizer or a beam shaping unit that generates an intensity distribution in the form of an inverse Gauss profile is arranged downstream of the laser referred to the beam direction.

16. The device according to claim 11,
wherein the annular doctor blade (6) is either coupled to a plane rotary gear or a displaceable device of variable length.
